(19) United States
(12) Patent Application Publication
(10) Pub. No.: US 2013/0106079 A1
(43) Pub. Date: May 2, 2013

(54) AIRBAG ARRANGEMENT FOR BULKHEAD SEATS

(71) Applicants: Patrick Jarboe, Davisburg, MI (US); Douglas Werth, Lake Orion, MI (US); Raj Valera, Rochester, MI (US)

(72) Inventors: Patrick Jarboe, Davisburg, MI (US); Douglas Werth, Lake Orion, MI (US); Raj Valera, Rochester, MI (US)

(21) Appl. No.: 13/284,024

(22) Filed: Oct. 28, 2011

(51) Int. Cl. B60R 21/16

(52) U.S. Cl. 280/730.1

(57) ABSTRACT

An airbag mounted on a bulkhead wall of an aircraft inflates downward in front of bulkhead seat occupants in a direction configured to make a first contact with a seat occupant's head. In a normal, deflated state, the airbag is mounted in a roll or folded bundle at a location on a bulkhead wall that approximately corresponds to an average seat occupant's chest or head height. Upon detonation of a pyrotechnical gas generator, the airbag unfolds initially downward. With increasing volume of the airbag, its increasing thickness pressing against the wall makes the airbag protrude from the wall toward a seat occupant's face so that the first contact with the airbag is made by the face of the seat occupant. The airbag may extend across a seat row and have adjacent chambers providing protection for seat occupants in adjacent seats.

### FIELD OF THE INVENTION

The invention relates to an airbag arrangement in an aircraft for the protection of bulkhead seat occupants.

### BACKGROUND OF THE INVENTION

Airbags have been credited for saving lives by damping impact of a vehicle crash on a vehicle occupant. Not only frontal airbags are in use, but also side impact airbags, such as curtain airbags expanding from the roof line of a vehicle or airbags arranged in a center console or armrest between two car seats. After the gas generator is triggered, the airbag unfolds and provides padding for the seat occupant. An airbag arranged in an armrest pushes itself between the seats and between seat occupants sitting next to each other. Another known airbag design provides an airbag in the vicinity of the center tunnel of the vehicle that inflates above the heads of the vehicle occupants to protect the occupants in the event of a vehicle rollover or of an “off-side” impact.

Airbags are designed to provide a synergetic effect with seat belts that restrain seat occupants in a defined position. At least the front seats of a vehicle and increasingly also the rear seats are provided with three-point seatbelts comprising a lap belt and a shoulder harness extending diagonally across a seat occupant's chest. The shoulder harness limits the forward movement of a seat occupant's upper body in the event of a frontal impact.

In contrast, aircraft passenger seats are usually only equipped with a two-point seatbelt, which is a lap belt without shoulder harness. In the event of a high deceleration of an aircraft, for instance during an emergency landing or a collision, the torso of a passenger is catapulted forward absent a shoulder harness. This constitutes a potentially dangerous situation, especially for passengers seated behind a wall in so-called bulkhead seats, where a forward movement is not limited by a padded seat back in front of the passenger. The passenger head may hit the wall or be flung downward without restraint.

### SUMMARY OF THE INVENTION

The object of the present invention is to provide an apparatus that improves the safety of aircraft seat occupants in bulkhead seats in the event of a high longitudinal deceleration.

According to the invention, this object is achieved by an airbag arrangement on a bulkhead wall that inflates in front of bulkhead seat occupants in a direction configured to make a first contact with a seat occupant's head. In a normal, deflated state, the airbag is mounted in a roll or folded bundle at a location on a bulkhead wall that approximately corresponds to an average seat occupant's seated chest or head height. Upon detonation of a pyrotechnical gas generator, the airbag unfolds in front of the seat occupant. With increasing volume of the airbag, its increasing thickness pressing against the wall makes the airbag protrude from the wall toward a seat occupant's face. When the seat occupant's head and torso, due to inertia, approach the wall, the first contact with the airbag is made by the face of the seat occupant. Any further forward and downward movement of the seat occupant's head and upper torso is dampened by the inflated airbag that acts like a voluminous pillow. The occupant's head sinks into the airbag and is prevented from whipping downward.

When several adjacent seats are arranged facing the wall, a plurality of airbag segments may be joined to a multi-seat airbag, each segment dimensioned to protect one seat occupant. The airbag segments may be inflated by one gas generator feeding all segments. Alternatively, each segment can feature its own gas generator with a discrete gas volume for each occupant.

In order to position the airbag relative to a seat occupant's head, an upper and a lower portion of each airbag section may be connected with a tether creating a horizontal fold that bends the lower portion toward the seat occupant for effective cushioning of the seat occupant's upper torso.

Further details and advantages become apparent from the following description of an embodiment of the invention. The drawings are provided solely for illustrative purposes and are not intended to limit the invention to the details shown.

### BRIEF DESCRIPTION OF THE DRAWINGS

In the drawings,

FIG. 1 shows a an aircraft bulkhead seat with an inflated airbag and a seat occupant after a frontal impact;

FIG. 2 shows the same situation as FIG. 1 without an airbag;

FIG. 3 shows a fabric pattern for an airbag extending across three seat widths with three airbag segments;

FIG. 4 shows the airbag of FIG. 3 in an inflated state; and

FIGS. 5a-e shows a sequence of events in the time window between a frontal impact and the situation shown in FIG. 2.

### DETAILED DESCRIPTION OF THE INVENTION

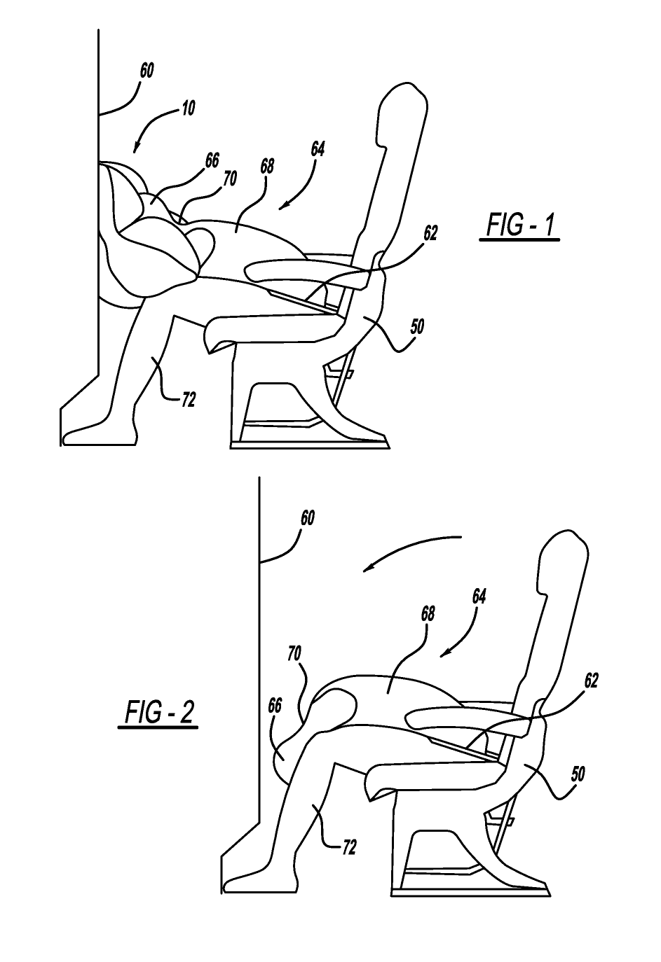

FIG. 2 shows an ordinary aircraft seat 50 located behind a bulkhead wall 60. The seat 50 features a lap belt 62 securing a seat occupant 64 in the seat 50. After a frontal impact or large longitudinal deceleration of the aircraft, the head 66 and the upper torso 68 of the seat occupant 64 are thrown forward by inertia, causing the head 66 and upper torso 68 to move to the front and around the lap belt 62 that produces a hinging motion. Depending on the deceleration magnitude, the head 66 may in incur a whipping movement downward when the upper torso 68 is stopped from moving further by the seat occupant's legs 72. This head movement exerts high forces on the seat occupant's neck 70 and may lead to injuries.

In contrast to the prior art configuration of FIG. 2, FIG. 1 shows an arrangement according to the present invention. The aircraft seat 50, the lap belt 62, and the bulkhead wall 60 are shown in the same positions relative to each other as in FIG. 2. The seat occupant 64 has been exposed to the same longitudinal deceleration as in FIG. 2. The bulkhead wall 60, however, features a bulkhead airbag 10 that is inflated during a deceleration event before the head 66 has approached the bulkhead wall 60. Accordingly, the head 66 contacts the inflated airbag 66 instead of continuing to move downward. The head 66 and the upper torso 68 retain an angle between each other that reduces the risk of neck injuries compared to the situation with a bare bulkhead wall 60 shown in FIG. 2.

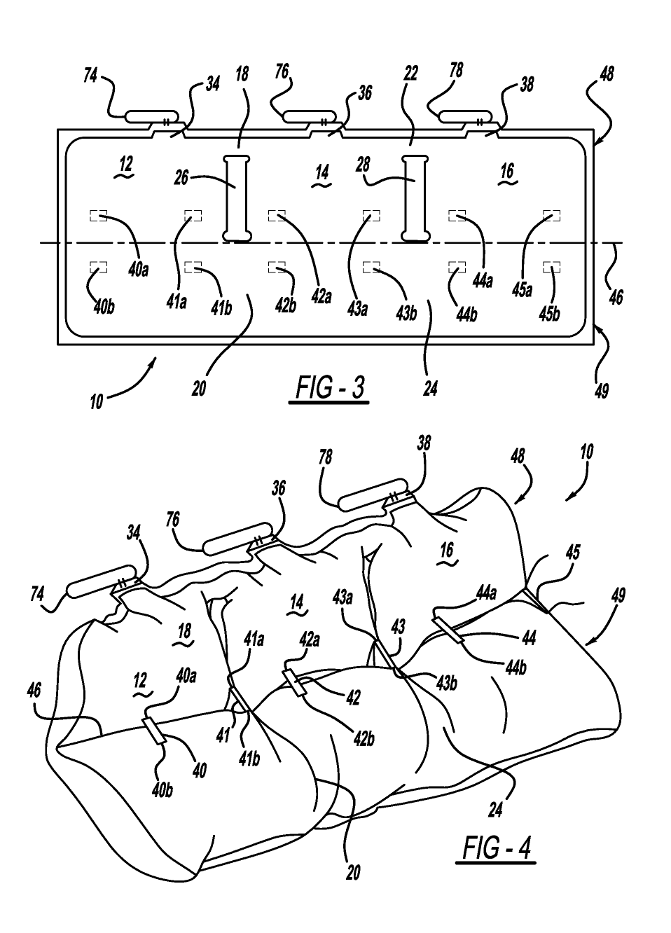

FIG. 3 shows an exemplary airbag 10 in a deflated, unfolded state. As is evident from FIG. 3, the airbag 10 can be constructed as a multi-passenger airbag. The airbag 10 of FIG. 3 features a face layer 30 and a wall layer 32 of fabric forming three chambers 12, 14, and 16 aligned next to each other. The face layer 30 faces the seat occupant 64 when inflated, and the wall layer 32 faces the bulkhead wall 60. The three chambers 12, 14, and 16 are each assigned to one seat occupant 64, respectively, sitting in adjacent seats 50. In an inflated state as further discussed in connection with FIG. 4, each of the chambers 12, 14, and 16 has a width that corresponds to the width of seat 50 so that each chamber 12, 14, and 16 extends across the front of one seat 50. The chambers 12 and 14 are connected through an upper channel 18 and a lower channel 20. Likewise, the chambers 14 and 16 are connected through an upper channel 22 and a lower channel 24. The channels 18 and 20 are formed by a first barrier 26, and the channels 22 and 24 are formed by a second barrier 28. The barriers 26 and 28 may be seams or baffles and connect the face layer 30 with the wall layer 32. The barriers leave the upper channels 18 and 22 with a smaller opening than the lower channels 20 and 24.

Each chamber 12, 14, and 16 has a port 34, 36, and 38, respectively, arranged along the same top edge of the airbag. Each port 34, 36, and 38 is connected to a respective gas generator 74, 76, or 78 for inflating the airbag 10 during a deceleration event. Accordingly, while each chamber 12, 14, and 16 is individually inflated primarily by a designated gas generator 74, 76, or 78, the chambers can also communicate and exchange inflation gas through the channels 18 through 24.

Notably, due to the small diameter of the upper channels 18 and 22, most of the gas generated by the gas generator 74, 76, or 78 associated with a given chamber 12, 14, or 16 fills the associated chamber first before reaching the lower channels 20 and 24 that provide a large diameter for communication. Thus, should one of the gas generators fail, the two remaining gas generators provide inflation gas for the chamber associated with the failing gas generator. Alternatively, one single gas generator, for example the centrally located gas generator 76, may be dimensioned to inflate all connected chambers. Such an arrangement sames costs by replacing the three gas generators 74, 76, and 78, with only one gas generator 76.

In FIG. 3, pairs of attachment points 40a and 40b, 41a and 41b, 42a and 42b, 43a and 43b, 44a and 44b, and 45a and 45b for tethers 40, 41, 42, 43, 44, and 45 are indicated with dotted lines. FIG. 4 illustrates the function of the attachment points 40a and 40b, 41a and 41b, 42a and 42b, 43a and 43b, 44a and 44b, and 45a and 45b in more detail.

FIG. 4 shows the airbag 10 of FIG. 3 in an inflated state. The tethers 40, 41, 42, 43, 44, and 45 are each connected with a first end to a first attachment point, 40a, 41a, 42a, 43, 44a, and 45a, located near a side of each chamber 12, 14, and 16 at a height at which the barriers 26 and 28 divide the airbag 10 into the chambers 12, 14, and 16 as shown in FIG. 3. A second end of each tether 40, 41, 42, 43, 44, and 45 is connected to a second attachment point 40a, 41a, 42a, 43, 44a, and 45a located at a height at which the chambers 12, 14, and 16 communicate through the lower channels 20 and 24. The tethers 40-45 are shorter than the distance between their associated attachment points on the face layer 30 of the airbag 10. Accordingly the airbag 10 inflates in an angled state with a horizontal fold in the face layer indicated by reference numeral 46. The fold 46 extends approximately near a lower end of the barriers 26 and 28. As a result, the airbag 10 is mostly separated into chambers 12, 14, and 16 in the area 48 above the fold 46, while it forms a nearly uniform cushion extending across all three chambers 12, 14, and 16 in the area 49 below the fold 46 due to the large opening cross-section of the lower channels 20 and 24.

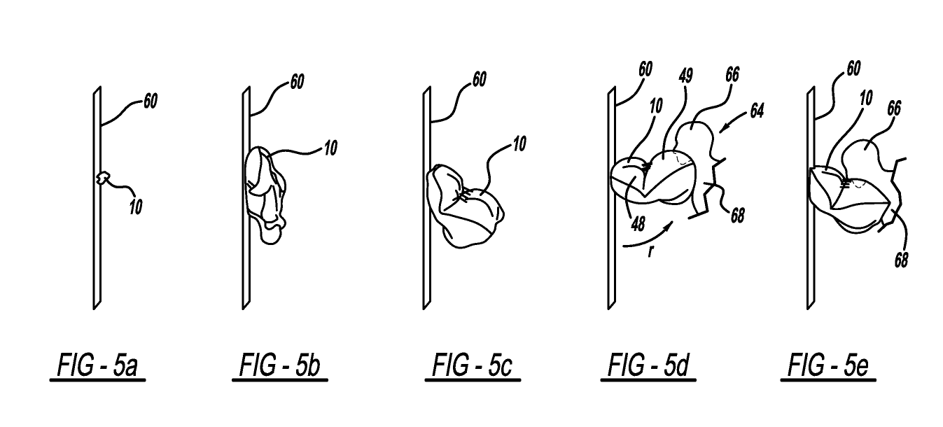

FIGS. 5 a through e illustrate and exemplary sequence of inflation when a high deceleration triggers the gas generators 74, 76, and 78 of airbag 10. FIG. 5 shows the incremental stages of inflation resulting in the situation previously discussed in connection with FIG. 1. In a normal, non-emergency, state as shown in FIG. 5a, the airbag 10 is rolled up or folded into an elongated bundle extending horizontally across the row of seats 50. The gas generators 74 through 78 (not shown) connected to the ports 34, 36, and 38 are fixedly attached to the bulkhead wall 60 in the aircraft at a height corresponding to an average seat occupant's chest or head height. When a deceleration of the aircraft exceeds a trigger threshold, the gas generators start to inflate the airbag 10. As shown in FIG. 5b, the airbag 10 unfolds downward. As more gas flows into the airbag, the airbag expands. Due to the barriers 26 and 28, the area 48 above the fold 46 exhibits a more limited expansion in the direction of the deceleration than the area 49 below the fold 46 as shown in FIG. 5c. Eventually, however, as shown in FIG. 5d, the area 48 above the fold 46 expands enough to push the airbag 10 toward the seat occupant 64 by abutting the bulkhead wall 60, thereby causing a rotation r about the gas generators 74 through 78 holding the ports 34, 36, and 38 fixed to the bulkhead wall 60. By the time the head 66 of the seat occupant 64 approaches the bulkhead wall 60, the lower portion 48 is suitably placed to contact the seat occupant's facial region to cushion the further movement of the head 66. As the head 66 moves downward as shown in FIG. 5e, the airbag 10 moves down with the head 66, finally resulting in the situation shown in FIG. 1.

As is evident from the shown example, the airbag 10 can be designed as an individual airbag for one seat occupant 64. Also, the tethers 40 can be omitted if area 48 and area 49 are sewn to each other at the attachment points, thus forming the fold 46. As different aircraft designs provide for different space between the aircraft seat 50 and the bulkhead wall 60, the design of the airbag 10 can be varied according to given dimensions without leaving the scope of the present invention.

Notably, the drawings show only an illustrative embodiment of the airbag. While the depicted airbag first unfolds downward and moves upward during inflation, variations of this design include individual or connected airbags that inflate directly toward the seat occupant's head and upper torso. Appropriate adaptable vents can be provided to reduce a risk of injury to the seat occupants,

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An airbag arrangement for protecting at least one seat occupant in an aircraft of the type having at least one seat for a seat occupant and a bulkhead wall, the seat facing a bulkhead wall, the airbag arrangement comprising:
an airbag assigned to the at least one seat and configured to inflate between the the bulkhead and the at least one seat;
at least one gas generator connected to the airbag and configured to inflate the airbag.

2. The airbag arrangement of claim 1, wherein the airbag is secured to the bulkhead wall.

3. The airbag arrangement of claim 2, wherein the airbag is secured at a height corresponding to a chest or head height of an average seat occupant.

4. The airbag arrangement of claim 1, wherein the at least one gas generator is connected to an upper portion of the airbag to inflate the airbag downward.

5. The airbag arrangement of claim 1, wherein the airbag arrangement is in an aircraft with a seating row of a plurality of adjacent seats facing the bulkhead wall and is assigned to the plurality of seats, the airbag arrangement further comprising that the airbag has a width corresponding to the plurality of seats and includes a number of barriers that divide the width of the airbag into chambers, each chamber having a width of approximately one of the seats.

6. The airbag arrangement of claim 5, wherein each barrier is configured to leave open an upper channel and a lower channel for communication between two adjacent chambers.

7. The airbag arrangement of claim 6, wherein the upper channel is narrower than the lower channel.

8. The airbag arrangement of claim 5, wherein the airbag has a facing the seat and a wall layer and the barriers are seams attaching the face layer to the wall layer.

9. The airbag arrangement of claim 5, further comprising that each chamber has one port connected to a dedicated gas generator, the ports being arranged on the same side of the airbag.

10. The airbag arrangement of claim 9, wherein the gas generators are mounted on the bulkhead wall at a height corresponding to the chest or head height of the average seated seat occupant.

11. The airbag arrangement of claim 1, further comprising a face layer facing the seat and a wall layer facing the bulkhead wall, the face layer having at least one pair of connected attachment points consisting of a first attachment point and a second attachment point, the first attachment point being located above the second attachment point, and the first attachment point being directly or indirectly affixed to the second attachment point at a distance that is shorter than the distance of the first and second attachment points along the face layer.

12. The airbag arrangement of claim 11, further comprising that each pair of attachment points has a tether connecting the first attachment point with the second attachment point.

13. The airbag arrangement of claim 12, wherein the tether has a length configured to create a substantially horizontal fold in the face layer.

14. The airbag arrangement of claim 11, further comprising that each chamber has two pairs of attachment points for each seat to which the airbag is assigned.
